(19) United States
(12) Patent Application Publication
(10) Pub. No.: US 2022/0308227 A1
(43) Pub. Date: Sep. 29, 2022

(54) Apparatus for Surveying an Environment

(71) Applicant: RIEGL Laser Measurement Systems GmbH, Horn (AT)

(72) Inventor: Peter RIEGER, Grossau (AT)

(73) Assignee: RIEGL Laser Measurement Systems GmbH, Horn (AT)

(21) Appl. No.: 17/704,234

(22) Filed: Mar. 25, 2022

(30) Foreign Application Priority Data
Mar. 25, 2021 (EP) 21 164 901.7

(51) Int. Cl. G01S 17/89; G01S 7/481; G01S 7/4865

(52) U.S. Cl. CPC G01S 17/89; G01S 7/4817; G01S 7/4865; G01S 7/4814

(57) ABSTRACT

An apparatus for surveying an environment comprises a first and at least one further scanning unit each for transmitting a pulse train of laser pulses over successive deflection periods at a pulse repetition rate, wherein the laser pulses falling in each deflection period form, per deflection period, a scanning fan which the laser pulses scan with a predeterminable angular velocity profile, and for receiving the associated laser pulses reflected by the environment. All the scanning fans overlap as seen in the direction of one of the scanning axes. The apparatus further comprises a control device connected to the at least one further scanning unit and configured to pivot the scanning fans of each further scanning unit relative to the scanning fans of an adjacent scanning unit by a pivot angle dependent on the pulse repetition rate and the angular velocity profile, in such a way that their sampling points do not coincide.

### CROSS-REFERENCE TO RELATED APPLICATIONS

This application claims priority to the European Patent Application No. 21 164 901.7 filed Mar. 25, 2021, the disclosure of which is incorporated herein by reference.

### TECHNICAL FIELD

The present disclosed subject matter relates to an apparatus for surveying an environment by time-of-flight measurement of laser pulses reflected from the environment in a coordinate system, comprising a first scanning unit for transmitting a first pulse train of laser pulses over successive deflection periods at a pulse repetition rate, wherein the laser pulses falling in each deflection period are transmitted in first scanning directions fanned out about a first scanning axis and thus form, per deflection period, a first scanning fan, which they scan with a predeterminable angular velocity profile, and for receiving the associated laser pulses reflected from first sampling points of the environment.

### BACKGROUND

Apparatuses of this type are described, for example, in EP 3 182 159 B1 and are carried by an aircraft or ship, for example, in order to topographically survey environments such as the ground or the seabed. It is also possible to mount such an apparatus on a land vehicle, for example to survey house façades, urban canyons or tunnels as vehicle travels past them. The apparatus can also be erected in a stationary manner, for example in an open-pit or underground mine in order to survey the excavation of the mine, above a conveyor belt in order to survey objects moved thereon, etc.

The scanning unit transmits laser pulses in a wide range of different scanning directions to many target points (“sampling points”) in the environment, and on the basis of time-of-flight measurements of the target reflections, the target distances are determined and on this basis—knowing the arrangement of the scanning unit and the respective scanning direction—a point model (“3D point cloud”) of the environment is created. In the case of mobile, vehicle-based apparatuses, the scanning fan, which is spanned by the scanning directions of the laser pulses of a deflection period, is guided over the environment by the movement of the vehicle. In the case of stationary apparatuses, the scanning fan is pivoted around, for example by means of a rotation of the scanning unit, in order to scan the environment. Likewise, the environment to be surveyed can be moved relative to the scanning fan, for example for surveying objects on conveyor belts.

It is desirable to create the 3D point cloud as quickly as possible and with a high spatial resolution. However, there are limits to the resolution of the point cloud. For example, the pulse repetition rate, which significantly influences the number of sampling points and thus the resolution of the 3D point cloud, cannot be increased arbitrarily: With a high pulse repetition rate or greater target distance, for example, the next laser pulse is already transmitted before the reflected first transmission pulse is received, and therefore the incoming reception pulses can no longer be clearly assigned to their respective transmission pulse. This is known as the “multiple time around” (MTA) problem. The maximum size dₘₐₓ of a clearly surveyable distance range, a so-called MTA zone, results from the pulse repetition rate (PRR) and the speed of light c at dₘₐₓ=c/(2·PRR).

In addition, so-called “blind ranges” occur at the edges of each MTA zone due to the design, because the receiving electronics are saturated or overloaded by near reflections of a transmitted laser pulse on, for example, housing or mounting parts of the apparatus and are thus “blind” to the reception of a reflected laser pulse. The largest possible MTA zones are therefore desirable in order to minimise the number of “blind ranges” over the entire distance range to be surveyed. However, this in turn limits the pulse repetition rate and consequently the number of sampling points and thus the resolution of the 3D point cloud.

A mere increase in the number of sampling points in the 3D point cloud, however, does not necessarily increase its spatial resolution. For example, some target points can be sampled several times, i.e. local clusters of sampling points can form, and other areas of the environment can contain too few sampling points, so that the desired resolution of the 3D point cloud is not available over the entire environment. It is therefore essential to distribute the sampling points as evenly as possible over the environment in order to achieve a high-quality 3D point cloud.

### BRIEF SUMMARY

The objective of the disclosed subject matter is to create an apparatus for laser scanning which enables a particularly rapid and powerful creation of a 3D point cloud of the environment.

This objective is achieved with an apparatus for surveying an environment by time-of-flight measurement of laser pulses reflected from the environment in a coordinate system, comprising

a first scanning unit for transmitting a first pulse train of laser pulses over successive deflection periods at a pulse repetition rate, wherein the laser pulses falling in each deflection period are transmitted in first scanning directions fanned out about a first scanning axis and thus form, per deflection period, a first scanning fan, which they scan with a predeterminable angular velocity profile, and for receiving the associated laser pulses reflected from first sampling points of the environment, and

at least one further scanning unit for transmitting a further pulse train of laser pulses over successive deflection periods with the pulse repetition rate, wherein the laser pulses falling in each deflection period are transmitted in further scanning directions fanned out about a further scanning axis and thus form, per deflection period, a further scanning fan, which they scan with the predeterminable angular velocity profile, and for receiving the associated laser pulses reflected from further sampling points of the environment,

wherein all scanning fans, seen in the direction of one of the scanning axes, substantially overlap, and

wherein a control device is connected to the at least one further scanning unit and configured to pivot the further scanning fans of each further scanning unit with respect to the scanning fans of an adjacent scanning unit in a predetermined sequence of the first and the at least one further scanning units by a pivot angle which is dependent on the pulse repetition rate and the angular velocity profile, in such a way that the further sampling points do not coincide with the first sampling points.

The laser scanning apparatus of the disclosed subject matter can transmit two or more scanning fans simultaneously due to its plurality of scanning units, whereby at least twice as many sampling points of the environment can be created for the point cloud in the same time. If the apparatus and the environment are additionally moved relative to each other in the scanning axis direction of a scanning fan, an area of the environment already scanned by a leading scanning fan as seen in the scanning axis direction can be scanned again by a trailing scanning fan as seen in this scanning axis direction, in the overlap area of the scanning fans. The pivoting of the scanning fans according to the disclosed subject matter prevents the laser pulses of the trailing scanning fan from possibly hitting the sampling points of the area already scanned by the leading scanning fan again, i.e. prevents the sampling points of the leading and trailing scanning fans from coinciding. This guarantees that the environment is actually surveyed with a higher resolution.

The pulse repetition rate and angular velocity can be fixedly predetermined for a specific surveying task or can change during the surveying process. The dependence according to the disclosed subject matter of the pivot angle on the pulse repetition rate and the angular velocity profile of the control device enables an operation that is adapted thereto automatically. The control device can measure these values itself, for example, or can receive them from a measuring unit or an actuator with which the measurement technician sets these values during operation.

Last but not least, each scanning unit only receives the laser pulses reflected by the environment in the respective scanning direction of its own scanning fan, whereby the laser pulses transmitted by different scanning units are geometrically separated at the receiver. This allows the number of laser pulses processed per time unit to be multiplied according to the number of scanning units without reducing the size of the MTA zones.

As a result, the apparatus of the disclosed subject matter achieves a particularly fast, high-quality and meaningful surveying of the environment.

As briefly discussed already above, an application of the apparatus of the disclosed subject matter is that it is mounted on a vehicle designed for a main direction of movement, e.g. on an aircraft, with each of its scanning axes being non-normal to the main direction of movement. This ensures that the main direction of movement has a component in the direction of the scanning axis, in which the scanning fans overlap with one another. This allows a trailing scanning fan seen in this direction to rescan an environment area already scanned by a leading scanning fan seen in this direction in order to increase therein the density of the sampling points in the 3D point cloud.

In a further embodiment, the control device is configured to predetermine the angular velocity profile depending on at least one past distance measurement value of the environment. On the one hand, this allows the distances between the sampling points within a scanning fan and, on the other hand, the distances between two successive scanning fans of a scanning unit to be homogenised. For example, the apparatus could be mounted on an aircraft and the control device could predetermine the angular velocity profile depending on the flight altitude in such a way that a higher flight altitude is accompanied by higher angular velocities and a lower flight altitude is accompanied by lower angular velocities in order to achieve, as far as possible, the same sampling point distances within the scanning fans and the same scanning fan distances at a constant pulse repetition rate over the entire environment to be surveyed.

In principle, the scanning fans of different scanning units can be positioned in any arrangement relative to each other, provided they overlap as seen in the direction of one of the scanning axes. In an advantageous embodiment, however, all scanning axes coincide. This means that the scanning fans are parallel and originate from a single scanning axis. The pivot angle applied to the scanning fans of a scanning unit is thus no longer dependent on a possible angle of inclination between the different scanning axes.

Coinciding scanning axes also allow the pivot angle to be determined independently of the distance of the environment. This makes it particularly easy to determine the pivot angle required to homogenise the sampling points and to use it for different environment topographies. In addition, the use of a common scanning axis allows a maximisation of the overlap area of the scanning fans and thus of the width of the scan strip in which the environment can be scanned at the improved resolution.

In the case of coinciding scanning axes, it is particularly advantageous if the control device is also configured to pivot the further scanning fans of each further scanning unit with respect to the scanning fans of a scanning unit that is adjacent in the predetermined sequence, in such a way that the scanning directions of the scanning fans, when they occupy substantially the same plane in the coordinate system, are arranged about the scanning axes at regular angular intervals. The scanning fans can occupy the same plane in the coordinate system in two ways: Firstly, when the apparatus is moved relative to the environment and a scanning unit trailing in the direction of movement transmits its scanning fan in that plane in which a scanning unit leading in the direction of movement had already transmitted a scanning fan, so that these scanning fans transmitted with a time offset successively occupy the same plane. This is the case when the environment is moved relative to the apparatus and vice versa. Secondly, when different scanning units transmit their scanning fans at the same time in the same plane, so that they permanently occupy the same plane. The regular arrangement of the scanning directions in the angular range can prevent a possible coincidence of the sampling points of different scanning fans in the environment, regardless of their distance, and thus the resolution of the 3D point cloud can always be increased, regardless of the topography.

In particular, it is favourable for this purpose if the pivot angle between the scanning fans of each two scanning units adjacent to one another in the sequence, when the scanning fans occupy substantially the same plane in the coordinate system, increased by the angular difference between the scanning directions first-scanned in each of these two scanning fans, corresponds to the angle between two scanning directions successively scanned in a scanning fan, divided by the number of all scanning units, optionally increased by a multiple of this angle.

The disclosed subject matter provides two embodiments—optionally also combinable with each other—of scanning fan pivoting by the control device. In a first embodiment, this pivoting is achieved electronically by the control device being configured to pivot the further scanning fans of the at least one further scanning unit by controlling a time offset when transmitting its further pulse train of laser pulses. In doing so, the drive pulses of the laser sources of the scanning units are phase-shifted, for example by means of delay elements, which enables a particularly fast and precise pivoting of their scanning fans. In addition, the control software or hardware can be reproduced at low cost, thus facilitating the industrial production of the apparatus.

In a second embodiment, the pivoting is achieved optically by the control device being configured to pivot the further scanning fans of the at least one further scanning unit by controlling optical elements in the beam path of its laser pulses. The use of controlled optical elements, for example electro-optical elements, pivotable or rotatable mirrors, prisms, etc., in the beam path allows the scanning fans to be pivoted without trimming the fan angle.

The scanning units of the apparatus can be constructed, for example, with oscillating mirrors, rotating mirrors, Palmer scanners or the like. In a further apparatus design, each scanning unit comprises a deflection device with a mirror prism rotatable about a prism axis, lateral sides of which prism each form a mirror face, and the prism axis of which prism is the scanning axis, and a laser transmitter for transmitting the respective pulse train of laser pulses in a respective transmission direction to the deflection device. With such a rotating mirror prism, a constant angular velocity profile can be achieved when proceeding over the scanning fan and then jumping back to the beginning of the scanning fan in the next deflection period, i.e. a line-by-line scanning of the environment at high speed.

If the deflection devices of all scanning units are optionally formed by one and the same deflection device, this results in a particularly compact design of the scanning units, and separate drives for each mirror prism can be omitted. In addition, the scanning directions of different scanning fans can be easily coordinated by referencing them to the one common mirror prism. Furthermore, as a result of the design, a single mirror prism leads to the same angular velocity profile for the scanning fans of all scanning units, so that they do not have to be synchronised separately.

In the optional apparatus design of the disclosed subject matter, the scanning directions of different scanning fans can be arranged regularly in the angular range, in particular by choosing the pivot angle between the scanning fans of each two scanning units adjacent to one another in the sequence as

$${λ}_{k , k - 1} = \frac{ω}{K \cdot PRR} + i \cdot \frac{ω}{PRR} - ( 2 \cdot ( {ϑ}_{k} - {ϑ}_{k - 1} ) + [ ω \cdot \frac{{D}_{k , k - 1}}{v} mod \frac{360 ° \cdot 2}{J} ] ) mod \frac{ω}{PRR} \qquad ( 1 )$$

with

K . . . number of scanning fans,

λ_{k,k-1} . . . pivot angle of the k-th scanning fan with respect to the (k−1)-th scanning fan,

ω . . . average angular velocity of the angular velocity profile,

PRR . . . pulse repetition rate,

i . . . an integer,

ϑₖ . . . (transmission direction of the k-th laser transmitter,

D_{k,k-1} . . . distance between the k-th and (k−1)-th scanning fans along the prism axis,

v . . . relative speed between apparatus and environment,

J . . . number of mirror faces and

mod . . . modulo operator.

In the aforementioned optional apparatus design of the disclosed subject matter, in particular three advantageous variants—which are optionally also combinable with each other—can be provided for the pivoting of the scanning fans by means of optical elements.

In a first variant, the laser transmitter has an adjustable deflection mirror lying in the beam path of the laser pulses, and the control device is configured to pivot the further scanning fans of said at least one further scanning unit by adjusting the deflection mirror. The arrangement of the deflection mirror defines the respective transmission direction and can be adjusted, for example, by an actuator connected to the control device. A lightweight deflection mirror can be adjusted particularly quickly due to its low mass inertia, so that a pivot required, for example due to a change in the angular velocity profile, can be carried out quickly. In addition, a deflection mirror can be adjusted over a large angular range and can thus also effect large changes in the transmission direction and the pivot angle.

In a second variant, the laser transmitter is arranged adjustably relative to the deflection device, and the control device is configured to pivot the further scanning fans of said at least one further scanning unit by adjusting the arrangement of the associated laser transmitter. In this variant, the laser transmitters are adjusted, for example pivoted or displaced, by actuators connected to the control device, so that large pivot angles can be achieved even without deflection mirrors.

In the first and the second variant, the reception aperture of the laser receiver of each further scanning unit could be enlarged for receiving the laser pulses of pivoted scanning fans, in such a way that the reflected laser pulses of the pivoted associated scanning fan still lie within this reception aperture. Alternatively, the laser receivers of the other scanning units can retain their reception aperture if the viewing direction of the laser receivers is also pivoted along with the associated scanning fan, for example by the control device controlling adjustable optical elements in the beam path of the reflected laser pulses or the arrangement of the laser receivers themselves.

In a third variant, the control device is configured to pivot the scanning fans of said at least one further scanning unit by controlling the phase shift of the rotational movement of the mirror prism. In this way, the mirror prisms, that are present anyway, can—for example by appropriately controlling their rotation axis drives—be used at the same time for pivoting the scanning fan, whereby there is no need for additional optical elements.

In a further embodiment of the disclosed subject matter, all scanning fans originate from the same point, whereby a spacing of the scanning fan vertices does not have to be taken into account during the pivoting of the scanning fans. In addition, this allows a particularly compact design because a mirror prism of short length can be used for transmission.

In particular, in the case of coinciding scanning axes, the regular arrangement of the scanning directions of all scanning fans when they occupy substantially the same plane in the coordinate system, can be achieved by choosing the pivot angle between the scanning fans of each two scanning units adjacent to each other in the sequence as

$${λ}_{k , k - 1} = \frac{ω}{K \cdot PRR} + i \cdot \frac{ω}{PRR} - [ ( {R}_{k , 1 , p} - {R}_{k - 1 , 1 , p} ) mod \frac{ω}{PRR} ] \qquad ( 2 )$$

with

K . . . number of scanning fans,

λ_{k,k-1} pivot angle of the k-th scanning fan relative to the (k−1)-th scanning fan (k=1 . . . K),

ω . . . average angular velocity of the angular velocity profile,

PRR . . . pulse repetition rate,

i . . . an integer,

R_{k,1,p} . . . first-scanned scanning direction of the k-th scanning unit in a reference deflection period,

R_{k-1,1,p′} first-scanned scanning direction of the (k−1)-th scanning unit in that deflection period in which its scanning fan occupies substantially the same plane in the coordinate system as the scanning fan of the k-th scanning unit in the reference deflection period, and

mod . . . modulo operator.

As can be seen from equation (2), only the first-scanned scanning directions of the scanning units in the respective deflection periods, the pulse repetition rate and the angular velocity profile are included in the determination of the pivot angle, so that the pivot angle is independent of the topography of the environment to be surveyed and the relative speed between the apparatus and the environment.

### BRIEF DESCRIPTION OF THE DRAWINGS

The disclosed subject matter will be explained in the following with reference to exemplary embodiments shown in the accompanying drawings, in which:

FIG. 1 shows a schematic perspective view of a laser scanning apparatus mounted on an aircraft and one of its scanning units when transmitting its scanning fan to survey an environment;

FIG. 2 shows a block diagram of a transmitting and receiving channel of the apparatus of FIG. 1 with schematically drawn beam paths;

FIGS. 3a-3d show a schematic perspective view of four different embodiments of the laser scanning apparatus, each mounted on an aircraft when surveying an environment with three scanning units, each transmitting a scanning fan and each forming a transmitting and receiving channel;

FIG. 4 shows an exemplary intensity/time graph of pulse trains of laser pulses transmitted by the scanning units of the laser scanning apparatuses of FIGS. 3a-3d;

FIG. 5 shows a plan view of an exemplary sampling point distribution on the environment, as would be obtained with the scanning fans of FIG. 3a, but without pivoting according to the disclosed subject matter for the pulse trains of FIG. 4;

FIG. 6 shows the pivoting of the scanning fans of the embodiment of FIGS. 3a-3d according to the disclosed subject matter, seen in the direction of the scanning axes;

FIG. 7 shows a plan view of an exemplary sampling point distribution on the environment, as obtained with the pivoted scanning fans of FIG. 6;

FIG. 8 shows an intensity/time graph of temporally staggered pulse trains of laser pulses, which are used in a first, electronically implemented embodiment for scanning fan tilting in the laser scanning apparatuses of FIGS. 3a-3d;

FIG. 9 shows the first, electronically implemented embodiment of the laser scanning apparatuses of FIGS. 3a-3d in a block diagram with schematically drawn beam paths;

FIGS. 10 and 11 show different variants of a second, optically implemented embodiment of the laser scanning apparatus of FIGS. 3a and 3b, once in a perspective view (FIG. 10) and once viewed in the scanning axis direction (FIG. 11), each with schematically drawn beam paths.

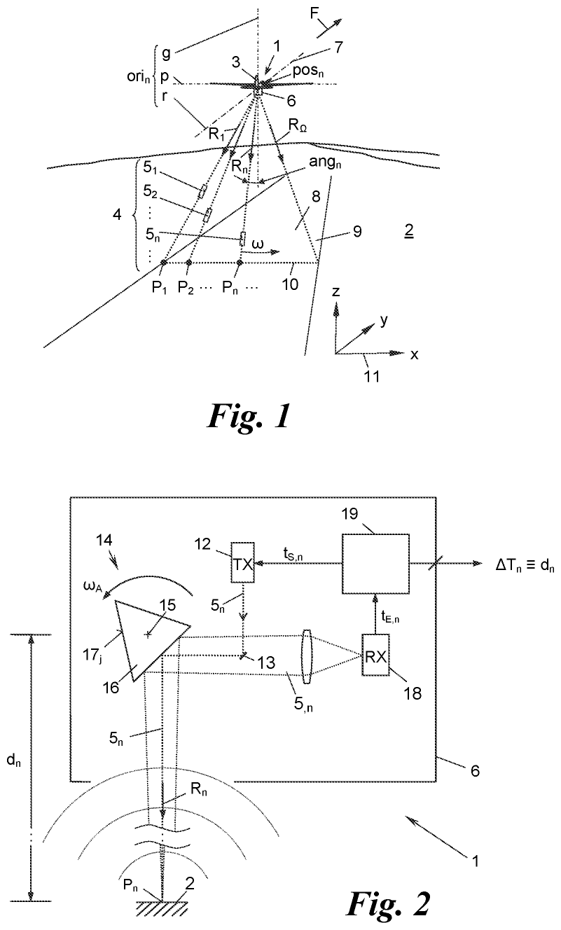

FIG. 1 shows an apparatus 1 for surveying an environment 2 from a vehicle 3. The environment 2 to be surveyed can be, for example, a landscape (terrain), but also the road surface and the façades along a stretch of road, the inner surface of a hangar, a tunnel or mine, or the sea surface or seabed, etc.

The vehicle 3 can be a land, air or water vehicle, manned or unmanned. Alternatively, the apparatus 1 could also be stationary and survey either a stationary environment 2 or one that moves relative to the apparatus 1, for example objects moving on a conveyor belt, workpieces, etc.

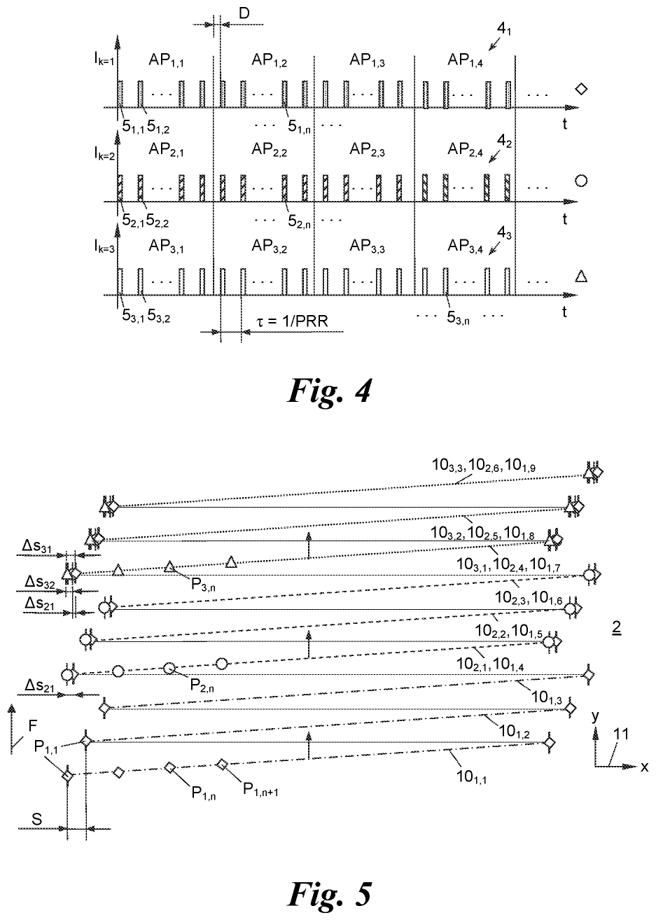

The apparatus 1 scans the environment 2 by means of a transmitted train 4 of laser pulses 5ₙ (n=1, 2, . . . ) for the purpose of surveying said environment. For this purpose, the laser pulses 5ₙ are transmitted by a scanning unit 6 in scanning directions Rₙ which are pivoted about a scanning axis 7 with a deflection period AP (see later FIG. 4). As a result, the scanning directions Rₙ of the laser pulses 5ₙ fan out, within a deflection period AP between a first-scanned scanning direction R₁ and a last-scanned scanning direction R_{Ω}, a scanning fan 8, which they scan with an angular velocity profile ω. The angular velocity profile co is determined by the specific design of the scanning unit 6 and can either be constant over the deflection period AP, i.e. ω=constant, or can change within the deflection period AP or for scanning directions Rₙi.e. ω=ω(t) or ω=ω(Rₙ).

In addition, the apparatus 1 is moved forward in the direction of travel F of the vehicle 3 at a relative speed v to scan the environment 2 substantially in a scan strip 9. If the vehicle 3 is an aircraft, the direction of travel F is the main direction of flight of the aircraft for which it is built. To this end, the direction of travel F is not in the plane of the scanning fan 8. In the case shown, the direction of travel F is normal to the plane of the scanning fan 8, so that the scanning fan 8 lies in the nadir direction of the vehicle 3 and is directed downwards towards the environment 2. However, the scanning fan 8 can also be rotated, for example about a vertical axis g of the vehicle 3, so that its intersection lines 10 with the environment 2, the “scan lines”, in the scan strip 9 lie obliquely to the projected direction of travel F. Similarly, the scanning fan 8 could be rotated about a pitch axis p and/or roll axis r of the vehicle 3.

Each laser pulse 5ₙ is transmitted by the apparatus 1 to the environment 2, reflected by the environment at a sampling point (“target point”) Pₙ of the environment 2 back to the apparatus 1 and received by the scanning unit 6. From a time-of-flight measurement of the laser pulses 5ₙ, distance measurement values dₙ from the current position posₙ of the apparatus 1 to the respective sampling point Pₙ of the environment 2 can be calculated using the known relationship

dₙ=c·Tₙ/2=c·(t_{E,n}−t_{S,n})/2 (3)

with

t_{S,n} . . . transmission time of the laser pulse 5ₙ,

t_{E,n} . . . reception time of the laser pulse 5ₙ and

c . . . speed of light.

Knowing the respective position posₙ of the apparatus 1 at the time of transmission of the laser pulse 5ₙ in a local or global x/y/z coordinate system 11 of the environment 2, the respective orientation orin of the apparatus 1 in the coordinate system 11, indicated, for example, by the tilt, roll and yaw angles of the vehicle 3 about its transverse, longitudinal and vertical axes p, r, g, and the respective angular position angₙ of the laser pulse 5ₙ in the direction of the point Pₙ with respect to the vehicle 3, the position of the sampling point Pₙ in the coordinate system 11 can then be calculated from the respective distance measurement value dₙ. A large number of such surveyed and calculated sampling points Pₙ map the environment 2 in the form of a “3D point cloud” in the coordinate system 11.

FIG. 2 shows the time-of-flight measurement principle of the apparatus 1 in a transmitting/receiving channel of the apparatus 1, which is responsible for the scanning fans 8 of the scanning unit 6 shown by way of example in FIG. 1.

According to FIG. 2, the laser pulses 5ₙ are transmitted in each transmitting/receiving channel of the apparatus 1 by a laser transmitter 12 via a deflection mirror 13 and a deflection device 14. In FIG. 2 the deflection device 14 is a mirror prism 16 rotating about its prism axis 15 with a predeterminable angular velocity ω_{A}, the lateral sides of which prism each form a mirror face 17ⱼ (j=1, 2, . . . , J) and the prism axis 15 of which prism is the scanning axis 7. In this case, the constant or variable angular velocity ω_{A} and the number J of mirror faces 17ⱼ give the described angular velocity profile co and the duration T_{AP} of a deflection period AP according to the formulas ω=2·ω_{A} and AP=360°/(ω_{A,d}·J), wherein ω_{A,d} denotes the average angular velocity ω_{A}. Alternatively, the deflection device 14 could be implemented by any other deflection device known in the prior art, for example an oscillating mirror, rotating mirror pyramid, etc. Similarly, the laser transmitter 12 could also transmit to the deflection device 14 non-normally to the prism axis 15, whereby for example the angular velocity profile ω is calculated according to the formula ω=G·ω_{A}, wherein G is a geometric projection factor G≠2.

The transmitted laser pulses 5ₙ are received back on the same path via the deflection device 14 after reflection at the respective environment point Pₙ and strike a laser receiver 18, i.e. the current viewing direction of the laser receiver 18 is equal to the current scanning direction Rₙ. The transmission times t_{S,n} of the laser pulses 5ₙ and the reception times t_{E,n} of the environment-reflected laser pulses 5ₙ are fed to a distance calculator 19, which calculates the respective distance dₙ therefrom using equation (3).

The pulse rate (pulse repetition rate, PRR) of the laser pulses 5ₙ is constant or can be modulated, for example for resolving MTA (multiple time around) ambiguities within a deflection period AP, in order to facilitate the assignment of transmitted and received laser pulses 5ₙ to each other, as known in the art.

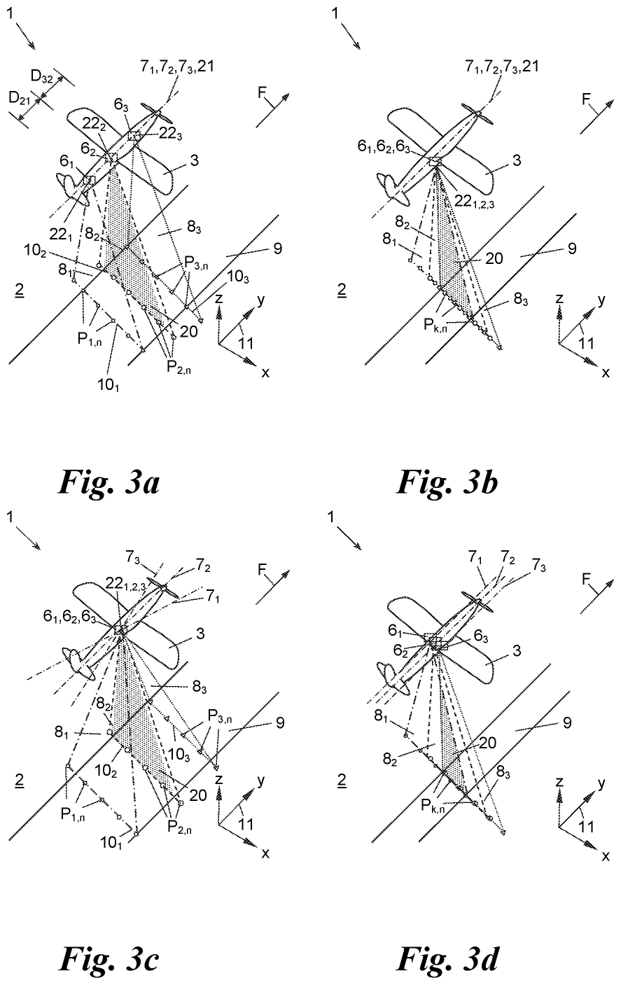

In FIGS. 1 and 2, only the scanning fans 8 of a scanning unit 6 of the apparatus 1 or the associated transmitting/receiving channel were shown to explain the measuring principle. By contrast, FIGS. 3a-3d each show the laser scanning apparatus 1 carried on the aircraft 3 with several (here: three) scanning units 6ₖ (k=1, 2, . . . , K; here K=3) as described in conjunction with FIGS. 1 and 2, i.e. in a predetermined sequence of a “first”, “second” and “third” scanning unit 6₁, 6₂, 6₃. It is understood that the apparatus 1 can have any number K>1 of scanning units 6ₖ.

Each of the three scanning units 6ₖ repeatedly transmits its respective pulse train 4ₖ of laser pulses 5_{k,n} with the same pulse repetition rate PRR in scanning directions R_{k,n}, which are fanned out about a respective scanning axis 7ₖ. Per deflection period AP, the scanning directions R_{k,n} of a scanning unit 6ₖ thus span in each case an associated scanning fan 8ₖ and scan it with the same angular velocity profile ω.

In the embodiment of FIG. 3a, the scanning axes 7ₖ of the scanning fans 8ₖ lie on a common straight line 21, i.e. they coincide, and are spaced apart in the direction of the straight line 21 with mutual distances D_{k,k-1} from each other. As a result, the scanning fans 8ₖ of the scanning units 6ₖ are parallel. In the embodiment of FIG. 3b, both the scanning axes 7ₖ of the scanning fans 8ₖ and their vertices 22ₖ coincide, i.e. the scanning fans 8ₖ lie in a common plane and originate from a common vertex 22_{1,2,3}. In the embodiment of FIG. 3c, the scanning fans 8ₖ originate from a common vertex 22_{1,2,3} but are not parallel, but rather divergent from each other, i.e. their scanning axes 7ₖ do not coincide, but intersect at the common vertex 22_{1,2,3}. In the embodiment of FIG. 3d, the scanning fans 8ₖ are parallel and arranged in one plane, but their vertices 22ₖ are spaced apart.

In each of these embodiments of FIGS. 3a-3d, the scanning fans 8ₖ overlap each other substantially in a common overlap area 20 (hatched), as seen in the direction of one of the scanning axes 7ₖ, in which the sampling points P_{k,n} of several scanning fans 8ₖ thus come to lie, as seen in the direction of this scanning axis 7ₖ. As a result, those scanning fans 8ₖ which lie in one plane (FIGS. 3b and 3d) scan the overlap area 20 in the same deflection period AP by design; and in the case of those scanning fans 8ₖ which do not lie in the same plane (FIGS. 3a and 3c), a scanning fan 8ₖ₋₁trailing in the direction of one of the scanning axes 7ₖ follows a scanning fan 8ₖ leading in this direction due to the relative movement between apparatus 1 and environment 2 and scans once again that part of the common scan strip 9 that had already been surveyed by the leading scanning fan. For example, in FIGS. 3a and 3c, the trailing scanning fan 8₁ rescans the scan lines 10₂, 10₃ of its two leading scanning fans 8₂, 8₃, and the trailing scanning fan 8₂ rescans the scan lines 10₃ of its

leading scanning fan 8₃. The scanning fans 8ₖ are not necessarily flat. For example, in FIG. 3c, the scanning fans 8₁, 8₃, which are inclined forwards or backwards in the direction of travel F, can lie on slightly curved cone envelope surfaces, for example due to the deflection mechanism of the laser pulses 5_{k,n}. This can be disregarded for the purposes of the present disclosed subject matter.

Instead of as shown in FIGS. 3a-3d, the scanning fans 8ₖ could also be in any other arrangement relative to each other, as long as they overlap each other at least in pairs in an overlap area 20.

FIGS. 4 and 5 illustrate an uncoordinated transmission of the pulse trains 4ₖ of each individual scanning unit 6ₖ, i.e. in each case without taking into account the other scanning units 6ₖ. For this purpose, FIG. 4 shows the intensities Ik of the laser pulses 5_{k,n} for each scanning unit 6ₖ plotted over the time t for several deflection periods AP_{k,p} (p=1, 2, . . . ) of its deflection device 14ₖ. FIG. 5 shows the scan lines 10_{k,p} generated by the scanning units 6ₖ for several deflection periods AP_{k,p}.

In the example shown, the pulse trains 4ₖ are transmitted synchronously with the same pulse repetition rate PRR, i.e. with a pulse spacing σ=1/PRR. Depending on the size of the pulse spacing τ, the deflection period AP_{k,p}, the relative speed v and the arrangement of the scanning fans 8ₖ, this results in different distributions of the sampling points P_{k,n}:

If the deflection period T_{AP} is a multiple of the pulse spacing τ, i.e. T_{AP}=m·T (m . . . a natural number), the laser pulses 5_{k,n} within each deflection period AP_{k,p} come to lie identically. As a result, the scanning directions R_{k,n} of different deflection periods AP_{k,p} of a scanning unit 6ₖ coincide and lie one behind the other as seen in the direction of travel F. If the angular velocity ω_{A} of the deflection device 14 and/or the relative velocity v is/are adjusted to a measured or expected distance d_{k,n} in the process, it can happen, depending on the magnitude of these values and the topography of the environment 2, that the sampling points P_{1,n} (shown as diamonds) and P_{2,n} (shown as circles) of the trailing scanning fans 8₁, 8₂ coincide with the already scanned sampling points P_{3,n} (shown as triangles) of the leading scanning fan 8₃.

If the deflection period TAP is not a multiple of the pulse spacing τ, i.e. T_{AP}≠m·τ, the laser pulses 5_{k,n} shift from deflection period AP_{k,p} to deflection period AP_{k,p+1} by a temporal drift D (FIG. 4), which pivots the scanning fans 8ₖ of successive deflection periods AP_{k,p} of one and the same scanning unit 6ₖ about the respective scanning axis 7ₖ, so that, for example, the first-scanned points P_{k,1} of successive deflection periods AP_{k,p}, AP_{k,p+1} of a scanning unit 6ₖ suffer a corresponding spatial offset S (FIG. 5), seen in the direction of travel F. If, as a result of the joint movement of the scanning units 6ₖ in the direction of movement F, the scan lines 10ₖ of a “trailing” scanning unit 6ₖ begin to slide over previous scan lines 10ₖ₊₁ of a “leading” scanning unit 6ₖ₊₁, as shown in FIGS. 4 and 5 for three exemplary scanning units 6₁, 6₂, 6₃, then the following usually happens: When scanning a scan line 10 several times, for example once as first scan line 10_{3,1} of the third (“leading”) scanning unit 6₃ in its first deflection period AP_{3,1}, once as fourth scan line 10_{2,4} of the second (“middle”) scanning unit 6₂ in its fourth deflection period AP_{2,4}, and once as seventh scan line 10_{1,7} of the first (“trailing”) scanning unit 6₁ in its seventh deflection period AP_{1,7}, the first-scanned scanning directions R_{1,1}, R_{2,1}, R_{3,1} of the scanning units 6, 6₁₂, 6₃ are each offset from one another by an angular difference Δφ₂₁, Δφ₃₁, Δφ₃₂ when scanning this scan line 10, so that the scanning directions R_{k,n} of all scanning units 6ₖ scan the overlap area 20 in the multiple-scanned line 10 or (here:) 10_{3,1}, 10_{2,4}, 10_{1,7} at irregular angular intervals.

As a result, the sampling points P_{3,n}, P_{2,n}, P_{1,n} within this scan line 10 or 10_{3,1}, 10_{2,4}, 10_{1,7} each come to lie differently, as a result of which the spatial distances Δs₂₁, Δs₃₁, Δs₃₂ between the associated sampling points P_{1,n}, P_{2,n}, P_{3,n} of the scanning units 6₁, 6₂, 6₃ are irregular.

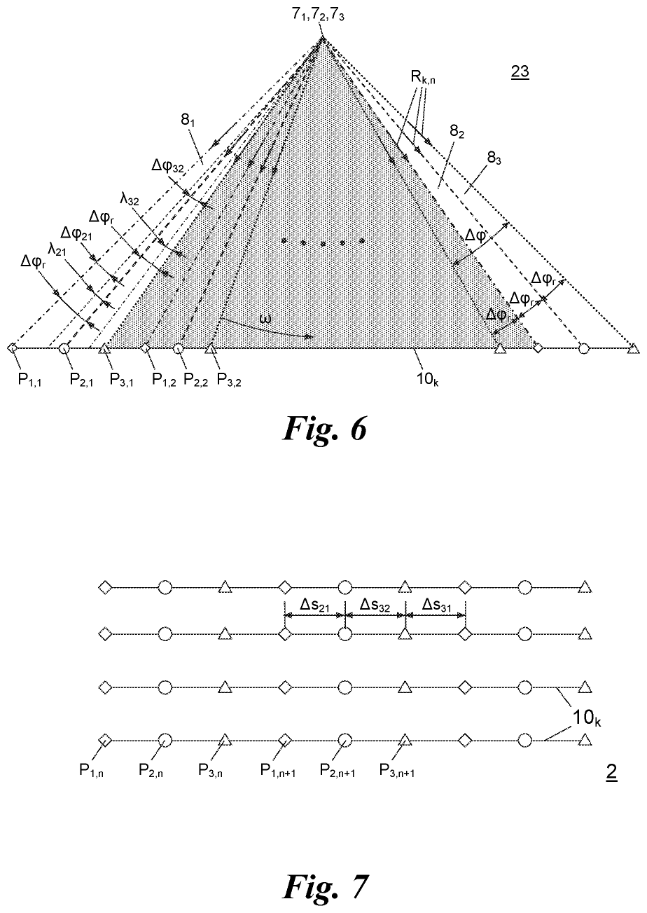

FIGS. 6 and 7 illustrate how such coincidence or irregular juxtaposition of the sampling points P_{k,n} of different scanning fans 8ₖ can be prevented and the sampling points P_{k,n} can be distributed more evenly over the environment 2.

For this purpose, as shown in FIG. 6, the scanning fans 8₂ of the second scanning unit 6₂ are pivoted with respect to the scanning fans 8₁ of the adjacent first scanning unit 6₁, and the scanning fans 8₃ of the third scanning unit 6₃ are pivoted with respect to the scanning fans 8₂ of the adjacent second scanning unit 6₂, by a respective pivot angle λ₂₁, λ₃₂ about their respective scanning axis 7ₖ. It should be mentioned that the order of the scanning units 6ₖ is arbitrary, i.e. which of the scanning units 6ₖ is designated as “first”, “second”, “third” etc. is arbitrary. The term “adjacent” scanning unit 6ₖ is therefore not to be understood in a local sense but in a numerical sense in this arbitrarily specified sequence.

For example, in the case of three scanning units 6₁, 6₂, 6₃, the pivot angles λ₂₁ and λ₃₂ are chosen in such a way that they, together with the respective angular difference Δφ₂₁, Δφ₃₂ caused by the drift D, produce one third of the angle Δφ between two successively scanned scanning directions R_{k,n} of a scanning fan 8ₖ, whereby the scanning directions R_{k,n} of all scanning fans 8₁, 8₂, 8₃, when these have passed through (“occupied”) one and the same plane 23 in the coordinate system 11 with respect to the environment 2, are arranged there at regular angular intervals Δφᵣ=Δφ/3 about the scanning axis 7ₖ. The angle Δφ can be determined as AΔφ=ω/PRR. In particular, the pivot angle λ_{k,k-1}, increased by the angular difference Δφ_{k,k-1} between the scanning directions R_{k,1} and R_{k-1,1} which are each first-scanned in these two scanning fans 8ₖ, 8ₖ₋₁, corresponds to the angle Δφ between two scanning directions R_{k,n} which are successively scanned in a scanning fan 8ₖ, divided by the number K of all scanning units 6ₖ, optionally increased by a multiple of this angle Δφ, for example an i-fold i·Δφ=i·ω/PRR, wherein i is an integer.

If, in addition, the pulse repetition rate PRR is chosen as a function of a measured or expected distance d_{k,n} to the environment 2 and is changed within the deflection period AP_{k,p}, the regular distances Δs₂₁, Δs₃₁, Δs₃₂ shown in FIG. 7 can be obtained over the entire scan line 10ₖ.

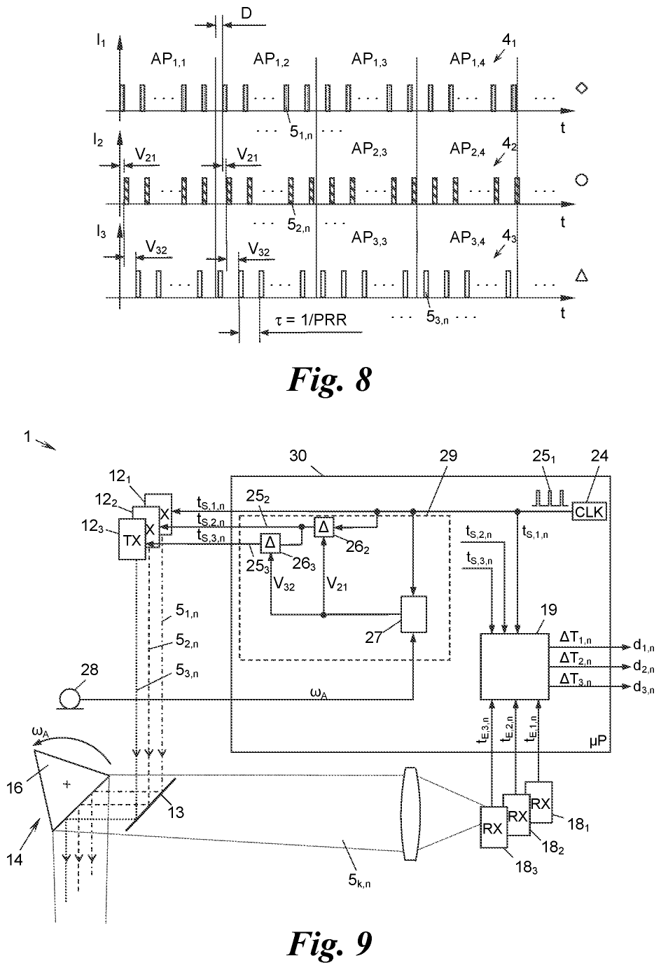

FIGS. 8 and 9 show a first practical embodiment for pivoting the scanning fans 8ₖ in the manner described in FIGS. 6 and 7, here by means of an electronically generated time offset Vₖ of the pulse trains 4ₖ of the scanning units 6ₖ.

FIG. 8 shows the pulse trains 4ₖ offset in this way and FIG. 9 the block diagram of such an electronic implementation of a three-channel apparatus 1 according to the exemplary embodiments 3a-3d. Each scanning unit 6ₖ comprises a laser transmitter 12ₖ and an associated laser receiver 18ₖ, which interact via a deflection device 14 common to all scanning units 6ₖ—in each case as shown in FIG. 2 for one channel—and are connected to a common distance computer 19 which calculates the respective distances d_{k,n} to the sampling points P_{k,n}. A clock generator 24 generates a control pulse train 25₁ for the laser transmitter 12₁ of the first scanning unit 6₁, which generates the first pulse train 4₁ from this. Delay elements 26₂, 26₃ delay the control pulse train 25₁ in cascade respectively by a time offset V₂₁ or V₃₂ and feed the control pulse trains 25₂, 25₃ delayed in this way to the laser transmitters 12₂, 12₃, which generate the pulse trains 4₂, 4₃ of the second and third scanning units 6₂, 6₃ from them.

The time offset V₂₁, V₃₂ to be respectively applied in the delay elements 26₂, 26₃ is predetermined by an offset computer 27. The offset computer 27 receives, for example, the control pulse train 25₁ from the clock generator 24 and the angular velocity ω_{A} of the deflection device 14 from an angular velocity sensor 28 and determines from this the pulse repetition rate PRR or the current angular velocity profile co and, depending on this, the time offsets V₂₁, V₃₂.

The offset computer 27 with the delay elements 26₂, 26₃ can thus also be regarded as a control device 29 which offsets the pulse trains 4ₖ of the scanning units 6ₖ with respect to one another in time and thus pivots the scanning fans 8ₖ about their scanning axes 7ₖ, i.e. the second scanning fans 8₂ with respect to the first scanning fans 8₁ by the angular offset λ₂₁ and the third scanning fans 8₃ with respect to the second scanning fans 8₂ by the angular offset λ₃₂.

The control device 29 can be implemented together with the distance computer 19 in a processor system 30, more specifically in hardware and/or software.

In particular, the offset computer 27 can specify the time offsets V₂₁, V₃₂ for the embodiment of FIG. 3b for an angular homogenisation of FIG. 6 according to the following formula:

$${V}_{k , k - 1} = \frac{1}{K \cdot PRR} + i \cdot \frac{1}{PRR} - \frac{1}{ω} [ ( {R}_{k , 1 , p} - {R}_{k - 1 , 1 , p} ) mod \frac{ω}{PRR} ] \qquad ( 4 )$$

with

K . . . number of scanning fans 8ₖ,

V_{k,k-}. . . time offset of the k-th pulse train with respect to the (k−1)-th pulse train (k=1 . . . K),

ω . . . average angular velocity of the angular velocity profile,

PRR . . . pulse repetition rate,

i . . . an integer,

R_{k,1,p} . . . first-scanned scanning direction of the k-th laser transmitter 12ₖ in a reference deflection period AP_{k,p},

v . . . relative speed between apparatus 1 and environment 2,

mod . . . modulo operator.

Optionally, the offset computer 27 can also determine the time offset V₂₁, V₃₂ to be applied depending on further values, for example the relative speed v, a measured or expected distance d_{k,n} or the arrangement of the scanning units 6ₖ, i.e. their positions and orientations, etc. In doing so, the offset computer 27 can preset the time offsets V₂, V₃₂ for the embodiment of FIG. 3a for an angular homogenisation of FIG. 6 according to the following formula:

$${V}_{k , k - 1} = \frac{1}{K \cdot PRR} + i \cdot \frac{1}{PRR} - \frac{1}{ω} [ ( {R}_{k , 1 , p} - {R}_{k - 1 , 1 , p} + [ ω \cdot \frac{{D}_{k , k - 1}}{v} mod ( ω \cdot {T}_{AP} ) ] ) mod \frac{ω}{PRR} ] \qquad ( 5 )$$

with

K . . . number of scanning fans 8ₖ,

V_{k,k-1} . . . time offset of the k-th pulse train with respect to the (k−1)-th pulse train (k=1 . . . K),

ω . . . average angular velocity of the angular velocity profile,

PRR . . . pulse repetition rate,

i . . . an integer,

R_{k,1,p} . . . first-scanned scanning direction of the k-th laser transmitter 12ₖ in a reference deflection period AP_{k,p},

D_{k,k-1} . . . distance between the k-th and (k−1)-th scanning fans 8ₖ,

v . . . relative speed between apparatus 1 and environment 2,

T_{AP} . . . deflection period duration and

mod . . . modulo operator.

Alternatively, the control device 29 can also allocate to each scanning unit 6ₖ within each deflection period AP_{k,p} fixed transmission times t_{s,k,n} based on the deflection period AP_{k,p}, for example by shifting the pulse trains 4ₖ of each scanning unit 6ₖ per deflection period AP_{k,p} by a time offset Vₖ, which it determines according to Vₖ=(k−1)/(K·PRR)−D, wherein D is the drift between two successive deflection periods AP_{k,p}, AP_{k,p+1}. For this purpose, the control device 29 could also be connected to the first scanning unit 6₁ in order to likewise pivot its scanning fans 8₁.

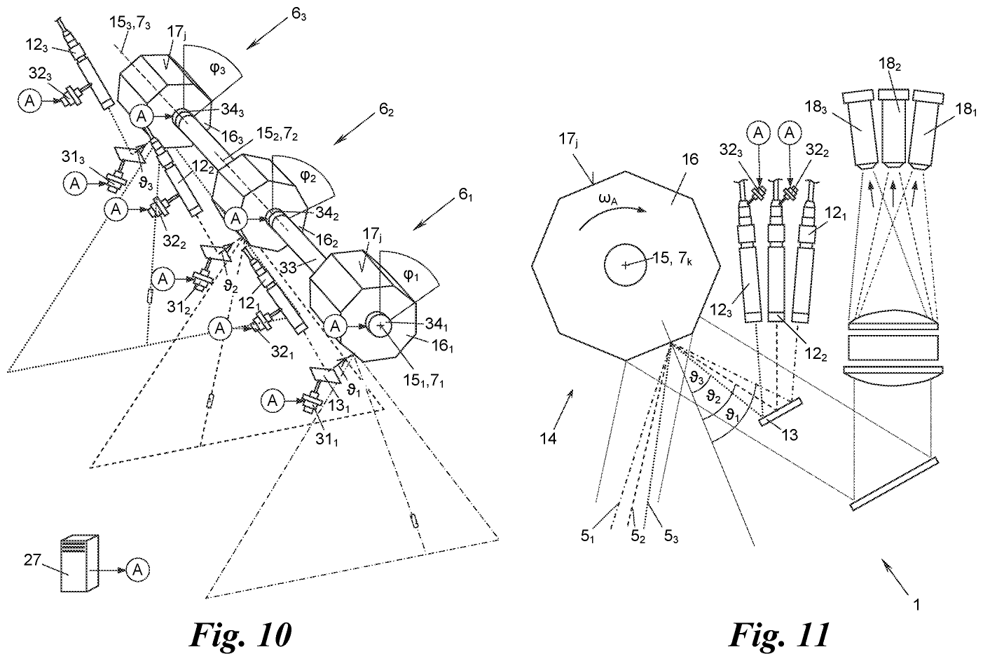

FIGS. 10 and 11 show a second practical embodiment for pivoting the scanning fans 8ₖ by means of a control device 29, which instead of delay elements 26₂, 26₃ for time offsets now contains adjustable optical elements, for example electro-optical elements, mirrors, prisms, etc. in the beam path of the laser pulses 5_{k,n} of the respective scanning fans 8ₖ. This is illustrated below in three exemplary variants using FIGS. 10 and 11, each of which shows a possible mechanical design of the embodiments of FIGS. 3a and 3b respectively.

In a first variant shown in FIG. 10, the control device 29 contains an actuator 31ₖ controlled by the offset computer 27 for each scanning unit 6ₖ, which actuator can adjust the arrangement of its deflection mirror 13ₖ. This changes a respective transmission direction ≥ₖ to the common mirror prism 16 or the respective mirror prism 16ₖ normal to the scanning axis 7ₖ.

In a second variant, also shown in FIG. 10 and in FIG. 11, the laser transmitters 12ₖ are adjustably mounted and the offset computer 27 controls actuators 32ₖ which can change the position and/or orientation, i.e. the arrangement, of the respective laser transmitter 12ₖ with respect to the common or respective mirror prism 16ₖ and thus the transmission direction ϑₖ.

It is understood that for the time-of-flight measurement, the laser pulses 5_{k,n} of the pivoted scanning fans 8ₖ must also be received by the associated laser receivers 18ₖ in the first and second variants. For this purpose, in one embodiment, these laser receivers 18ₖ have a reception aperture which is so large that the reflected laser pulses 5_{k,n} pass through it despite the pivoting of the associated scanning fan 8ₖ. In an alternative embodiment, these laser receivers 18ₖ retain their, for example optimally adapted, reception aperture and the viewing directions of these laser receivers 18ₖ are also pivoted along with the associated scanning fan 8ₖ. For this co-pivoting, the control device 29 could—as described in the first or second variant for the transmission channel—use actuators to control adjustable optical elements in the reception channel or the arrangement of these laser receivers 18ₖ themselves.

In a third variant, also shown in FIG. 10, the offset computer 27 controls actuators 34ₖ mounted on a common drive shaft 33 of the mirror prisms 16ₖ, with which actuators the mirror prisms 16ₖ can each be individually rotated relative to the drive shaft 33 in order to set the phase position φ_{k,k-1}=φₖ−φₖ₋₁=λ_{k,k-1}/2 between two mirror prisms 16ₖ, 16ₖ₋₁. In this way, the scanning fans 8ₖ of different scanning units 6ₖ are pivoted relative to each other again.

In the variants mentioned, the offset computer 27 thus forms, together with the actuators 31ₖ, 32ₖ, 34ₖ, the control device 29, which pivots the scanning fans 8ₖ of the scanning units 6ₖabout their scanning axes 7ₖ.

For an angular homogenisation of the scanning directions R_{k,n} in each of the three variants mentioned, the pivot angle λ_{k,k-1} can be determined, for example, as

$${λ}_{k , k - 1} = \frac{ω}{K \cdot PRR} + i \cdot \frac{ω}{PRR} - ( 2 \cdot ( {ϑ}_{k} - {ϑ}_{k - 1} ) + [ ω \cdot \frac{{D}_{k , k - 1}}{v} mod \frac{360 ° \cdot 2}{J} ] ) mod \frac{ω}{PRR} \qquad ( 1 )$$

or, in the embodiment of FIG. 11, with D_{k,k-1}=0 as

$${λ}_{k , k - 1} = \frac{ω}{K \cdot PRR} + i \cdot \frac{ω}{PRR} - [ 2 \cdot ( {ϑ}_{k} - {ϑ}_{k - 1} ) mod \frac{ω}{PRR} ] \qquad ( 6 )$$

or in general for parallel scanning fans 8ₖ, even if the transmission directions ϑₖ are not normal to the prism axis 15, as

$${λ}_{k , k - 1} = \frac{ω}{K \cdot PRR} + i \cdot \frac{ω}{PRR} - [ ( {R}_{k , 1 , p} - {R}_{k - 1 , 1 , {p}^{′}} ) mod \frac{ω}{PRR} ] \qquad ( 2 )$$

with

K . . . number of scanning fans 8ₖ,

λ_{k,k-1} . . . pivot angle of the k-th scanning fan 8ₖ with respect to the (k−1)-th scanning fan 8ₖ₋₁ (k=1 . . . K),

ω . . . average angular velocity of the angular velocity profile,

PRR . . . pulse repetition rate,

i . . . an integer,

ϑₖ . . . transmission direction of the k-th laser transmitter 12ₖ,

R_{k,1,p} . . . first-scanned scanning direction of the k-th scanning unit 6ₖ in a reference deflection period AP_{k,p},

R_{k-1,1,p′} . . . first-scanned scanning direction of the (k−1)-th scanning unit 6ₖ₋₁ in that deflection period AP_{k-1,p′} in which its scanning fan 8ₖ occupies substantially the same plane 23 in the coordinate system 11 as the scanning fan 8ₖ of the k-th scanning unit 6ₖ in the reference deflection period AP_{k,p},

D_{k,k-}. . . distance between the k-th and (k−1)-th scanning fans along the prism axis 15ₖ,

v . . . relative speed between apparatus 1 and environment 2,

J . . . number of mirror faces 17 and

mod . . . modulo operator.

It is understood that in equations (1) and (2) or (4), (5) and (6), a representation of the transmission directions ϑₖ or the first-scanned scanning directions R_{k,1,p} is to be chosen respectively as a scalar, for example as a direction angle in a projection plane common to all scanning fans 8ₖ, for example in the case of parallel scanning fans 8ₖ projected onto a common scanning fan plane, as shown in FIG. 11.

Of course, there can also be other optical elements upstream or downstream of the deflection device 14 in the beam path of the laser pulses 5_{k,n}, and these optical elements can be controlled by the offset computer 27 to pivot the scanning fans 8ₖ about and/or along the scanning axes 7ₖ.

The disclosed subject matter is not limited to the embodiments presented, but encompasses all variants, modifications and combinations thereof which fall within the scope of the appended claims.

What is claimed is:

1. An apparatus for surveying an environment by time-of-flight measurement of laser pulses reflected from the environment in a coordinate system, comprising
a first scanning unit for transmitting a first pulse train of laser pulses over successive deflection periods at a pulse repetition rate, wherein the laser pulses falling in each deflection period are transmitted in first scanning directions fanned out about a first scanning axis and thus form, per deflection period, a first scanning fan, which they scan with a predeterminable angular velocity profile, and for receiving the associated laser pulses reflected from first sampling points of the environment, and
at least one further scanning unit for transmitting a further pulse train of laser pulses over successive deflection periods at the pulse repetition rate, wherein the laser pulses falling in each deflection period are transmitted in further scanning directions fanned out about a further scanning axis and thus form, per deflection period, a further scanning fan, which they scan with the predeterminable angular velocity profile, and for receiving the associated laser pulses reflected from further sampling points of the environment,
wherein all scanning fans, seen in the direction of one of the scanning fans, substantially overlap, and
wherein a control device is connected to the at least one further scanning unit and configured to pivot the further scanning fans of each further scanning unit with respect to the scanning fans of an adjacent scanning unit in a predetermined sequence of the first and the at least one further scanning units by a pivot angle which is dependent on the pulse repetition rate and the angular velocity profile, in such a way that the further sampling points do not coincide with the first sampling points.

2. The apparatus according to claim 1, wherein it is mounted on a vehicle or aircraft designed for a main direction of movement with each of its scanning axes being non-normal to the main direction of movement.

3. The apparatus according to claim 1, wherein the control device is configured to predetermine the angular velocity profile depending on at least one past distance measurement value of the environment.

4. The apparatus according to claim 1, wherein all scanning axes coincide.

5. The apparatus according to claim 4, wherein the control device is configured to pivot the further scanning fans of each further scanning unit with respect to the scanning fans of a scanning unit that is adjacent in the predetermined sequence, in such a way that the scanning directions of the scanning fans, when they occupy substantially the same plane in the coordinate system, are arranged about the scanning axes at regular angular intervals.

6. The apparatus according to claim 4, wherein the pivot angle between the scanning fans of each two scanning units adjacent to one another in the sequence, when the scanning fans occupy substantially the same plane in the coordinate system, increased by an angular difference between the scanning directions first-scanned in each of these two scanning fans, corresponds to an angle between two scanning directions successively scanned in a scanning fan, divided by the number of all scanning units.

7. The apparatus according to claim 1, wherein the control device is configured to pivot the further scanning fans of the at least one further scanning unit by controlling a time offset when transmitting its further pulse train of laser pulses.

8. The apparatus according to claim 1, wherein the control device is configured to pivot the further scanning fans of the at least one further scanning unit by controlling optical elements in the beam path of its laser pulses.

9. The apparatus according to claim 1, wherein each scanning unit comprises:
a deflection device with a mirror prism rotatable about a prism axis, lateral sides of which mirror prism each form a mirror face, and the prism axis of which mirror prism is the scanning axis, and
a laser transmitter for transmitting the respective pulse train of laser pulses in a respective transmission direction to the deflection device.

10. The apparatus according to claim 9, wherein the deflection devices of all scanning units are formed by one and the same deflection device.

11. The apparatus according to claim 9, wherein all scanning axes coincide and wherein the pivot angle between the scanning fans of each two scanning units adjacent to one another in the sequence is chosen as
$${λ}_{k , k - 1} = \frac{ω}{K \cdot PRR} + i \cdot \frac{ω}{PRR} - ( 2 \cdot ( {ϑ}_{k} - {ϑ}_{k - 1} ) + [ ω \cdot \frac{{D}_{k , k - 1}}{v} mod \frac{360 ° \cdot 2}{J} ] ) mod \frac{ω}{PRR}$$
with
K . . . number of scanning fans,
λ_{k,k-1} . . . pivot angle of the k-th scanning fan with respect to the (k−1)-th scanning fan (k=1 . . . K),
ω . . . average angular velocity of the angular velocity profile,
PRR . . . pulse repetition rate,
i . . . an integer,
ϑₖ . . . transmission direction of the k-th laser transmitter,
D_{k,k-1} . . . distance between the k-th and (k−1)-th scanning fans along the prism axis,
v . . . relative speed between apparatus and environment,
J . . . number of mirror faces and
mod . . . modulo operator.

12. The apparatus according to claim 9, wherein the laser transmitter further comprises an adjustable deflection mirror lying in the beam path of the laser pulses, and the control device is configured to pivot the further scanning fans of said at least one further scanning unit by adjusting the deflection mirror.

13. The apparatus according to claim 9, wherein the laser transmitter is arranged adjustably relative to the deflection device, and the control device is configured to pivot the further scanning fans of said at least one further scanning unit by adjusting the arrangement of the associated laser transmitter.

14. The apparatus according to claim 9, wherein the control device is configured to pivot the further scanning fans of said at least one further scanning unit by controlling a phase shift of the rotational movement of the respective mirror prism.

15. The apparatus according to claim 1, wherein all scanning fans originate from the same point.

16. The apparatus according to claim 1, wherein all scanning axes coincide and wherein the pivot angle between the scanning fans of each two scanning units adjacent to one another in the sequence is chosen as
$${λ}_{k , k - 1} = \frac{ω}{K \cdot PRR} + i \cdot \frac{ω}{PRR} - [ ( {R}_{k , 1 , p} - {R}_{k - 1 , 1 , {p}^{′}} ) mod \frac{ω}{PRR} ]$$
with
K . . . number of scanning fans,
λ_{k,k-1} . . . pivot angle of the k-th scanning fan with respect to the (k−1)-th scanning fan (k=1 . . . K),
ω . . . average angular velocity of the angular velocity profile,
PRR . . . pulse repetition rate,
i . . . an integer,
R_{k,1,p} . . . first-scanned scanning direction of the k-th scanning unit in a reference deflection period,
R_{k-1,1,p′} first-scanned scanning direction of the (k−1)-th scanning unit in that deflection period in which its scanning fan occupies substantially the same plane in the coordinate system as the scanning fan of the k-th scanning unit in the reference deflection period, and
mod . . . modulo operator.
